(19) United States
(12) Patent Application Publication
(10) Pub. No.: US 2024/0358222 A1
(43) Pub. Date: Oct. 31, 2024

(54) Vertical Dish rack

(71) Applicant: Gregory C Matta, Las Vegas, NV (US)

(72) Inventor: Gregory C Matta, Las Vegas, NV (US)

(21) Appl. No.: 18/140,889

(22) Filed: Apr. 28, 2023

(51) Int. Cl. A47L 19/04; A47J 47/20

(52) U.S. Cl. CPC A47L 19/04; A47J 47/20

(57) ABSTRACT

A Vertical holding rack that has cantilever engineering makes it strong enough to hold a lot of objects with weight, with it easy to install and remove in all types of countertops. A vertical holding rack that the vertical dish rack that goes up vertically along the sink wall and cantilever up above the countertop and leans over into the sink to holds cooking and eating utensils, to drip-dry into the sink without water diverter. A dish rack makes all counter tops/HHS and sinks a more efficient area to place an object when you did not have the HHS countertop to put something there before in a limited small area.

### FIELD OF INVENTION

This invention is in the general field of countertops, which is a “Horizontal Holding Surface” (HHS). This HHS, which can be found in RV, commercial and domestic kitchens. Countertops are everywhere for working on objects in the kitchen and other types of HHS work areas.

### DESCRIPTION OF PRIOR ART

The problem of having a limited HHS area, this area can get overloaded. So therefore, there's a need in the Arts for a device and method that will solve this old annoying problem. This device works with a sink or without a sink. This device makes all HHS and kitchen sinks a more efficient area to place an object when you did not have the HHS to put something there before. therefore, creating a new type of drying rack to hold more objects in a small tight area. We have also addressed the water diverter problem that holds water and moisture that can cause mold, mildew and scum build up.

We have eliminated three problems that are not found in past art in drying racks and drying baskets. Other prior art and patents describing the closest subject matter provide for a number of more or less complicated features that fail to solve problems in an efficient economical way. None of these patents suggest the novel futures of the invention and its several embodiments.

A brief abstract of technical disclosure in specifications and title is provided as well for the purpose of complying with 37 CFR 1.72 and is not intended to be used for interpreting and limiting the scope of claims.

Without limiting the scope of the invention, a brief summary of some of the claimed embodiments of the invention is set forth below. Additionally details of the summarized embodiments of the invention may be found in the detailed description of the invention below.

### SUMMARY OF INVENTION

The object of the present invention is to have a rack that is easy to install, simply mounts and goes up vertically, it does not take up any HHS countertop space and holds objects.

The object of the present invention is not to have a water diverter to hold water that creates scum and mold build up that needs cleaning.

The object of the present invention is to eliminate the need for a ugly drying dish basket on the countertop or in the sink that takes up space and have a beautiful looking efficient modern Vertical holding rack instead, that takes up no space.

The object of present invention is to use the sink walls for the leg anchor to support to, so the device can cantilever up from the attachment point to balance the weight and stabilize the load of objects on the vertical holding rack that cantilever up and above the countertop off of the sink walls and attach to sink lip creating the present invention the Vertical Holding Rack (VHR) but will be sold in the kitchen section as the Vertical Dish Rack (VDR).

The object of the present invention is that it has numerous ways of attaching to a predetermined spot with attachment devices and different materials to connect to the sink with and other attaching locations. Also, this applies to other locations in many different variations for different sizes and models for the very differentiation of sinks, workstations, and other applications.

The object of present invention is to have a inexpensive version of this device made out of wire and rubber. This is for low budget customers and going up to high end customer. This will very in cost also for the different prong holding designs, different material and sizes for different models for all types of known applications and some unrecognized applications.

Further objects of the invention will be brought out in the following part of the specifications, wherein detailed descriptions is for the purpose of fully disclosing the inventions without placing limitations thereon.

These and other embodiments which characterized the invention are pointed out with particularity in the claims annexed hereto and forming a part hereof. However, for a better understanding of the invention its advantage and objectives obtained by its use, reference can be made to the drawings which form a further part hereof and the accompanying descriptive matter in which there are illustrated and described various embodiments of the invention.

### BRIEF DESCRIPTION OF DRAWINGS

FIG. 1 is a top view of the first embodiment that shows a standard dual kitchen sink 1000. This is with no faucet in the drawing to make it easier for the drawings of the invention showing it working correctly without being cluttered and creating confusion in the drawings.

FIG. 1 is also showing a standard duel drop in sink 1000 sitting on a standard counter top 1002 with a backsplash 1003 Which is a standard kitchen sink design in a standard kitchen or RV.

FIG. 2 is a front side cut view of a standard dual drop-in kitchen sink 1000 showing the sink lip 1005 sitting on and around the countertop 1002 holding the sink into place on the countertop. All so showing the sink divider 1007 with the drains 1001 and showing the vertical sink walls 1006 of a standard kitchen sink.

FIG. 3 is a left side cut view of a standard drop in kitchen or bathroom sink 1000 sitting on a countertop 1002 showing II the working components shown in FIGS. 1 and 2 of a standard kitchen or bathroom sink without faucets. Also showing the names of the components of the embodiment⋅labeled with numbers of the components in the drawings.

FIG. 4A is a front view of Vertical Dish Rack (VDR) 2000 showing the one type of holding prongs for the pots, plates or bowls 2001, also showing the holding prongs for glasses and cups 2003.

FIG. 4B is a front offset 3D view of the invention the VDR 2000 showing the two different types of prongs out of the five types shown in FIG. 4A the 2001 and the 2003 out of the four other prong types in this VDR model.

FIG. 5A is a 3D low side back view of the VDR 2000, showing the 3 attachment prongs 2004 and the 2 additional attachment spot 2005 for additional weight loads. Also showing the silverware prongs 2002 and showing the other prong. in front mentioned in FIGS. 4 A & B

FIG. 5B is a 3D front side view of the (VDR) 2000 with showing the holding prongs for pots, plates or bowls 2001. Also showing the holding prongs for silverware 2002, glasses and cups prongs 2003. Also showing the one of the 3 attachment prongs 2004 for the attachment of the VDR to sink. Also showing one of the additional attachment spot 2005 for additional support for heavy weight loads.

FIG. 6A is a 3D offset top front view showing the 2 wide silverware prongs 2002 and the 4 plate and bowl prongs 2001 and all the other embodiment's in FIGS. 4 and 5. FIG. 6 B Is also another 3D offset top back view of the VDR 2000 showing the three attachment prongs 2004 and also showing the 7 prongs for glasses and cups 2003 and all the other embodiment's in FIGS. 4, 5 and 6A of the VDR.

FIG. 7 is a top view of a standard sink 1000 showing not one but two vertical dish racks 2000 just for demonstration purposes. This is showing one of them sitting on the back of the sink and the other sitting on the left side of the sink. There are five 2000 with a circle around it and it is showing the other locations where one could be mounted.

FIG. 8 is a front side cut view of a standard sink 1000 showing 2 VDR's 2000 showing them mounted to the sink and on of them sitting on the back of the sink on the right hand side and one sitting on the left hand side of the sink just like in the drawings of FIGS. 7 & 9. Also showing the numbering of the labeling of the components to the vertical dish rack and a standard sink in a standard kitchen.

FIG. 9 is a left side cut view of a standard sink 1000 showing 2 VDR'S 2000 mounted to the sink the same as in FIG. 8 and a giving description by numbering all the components to this present invention in FIG. 8.

FIG. 10 is a front view of one VDR 2000 like in FIG. 4A and showing it installed like showing in FIGS. 7, 8 and 9 with no dishes. FIG. 10 shows it holding 3 plates 3001, a frying pan 3001, a pot 3001, four glasses 3003 and a handful of silverware 3002.

FIG. 11 is also identically the same as FIG. 10 but it is a left front 3D View of the VDR 2000 loaded with the same identical dishes.

FIG. 12 is identical to FIGS. 10 and 11, except it is a left back side 3D view of the VDR 2000 loaded with the same identical dishes.

FIG. 13 is also a left back side 3D view as in FIG. 12 but the pot 3001 is missing so you can see the silverware 3002 sitting in silverware prongs 2002 where they go and you can also see all four glasses 3003 hooked and sitting on 4 of the cup and glass prongs 2003 out of 7 prongs being held in place. You can also see the attachment prongs 2004 attached to the sink lip 1005 to secure and support the weight load of the vertical dish rack.

FIG. 14 is identical to FIGS. 10, 11 and 12 but this is a 3D top view of the same identical dishes.

### DETAILED DESCRIPTION OF SOME PREFERRED EMBODIMENT'S

### The Vertical Holding Rack

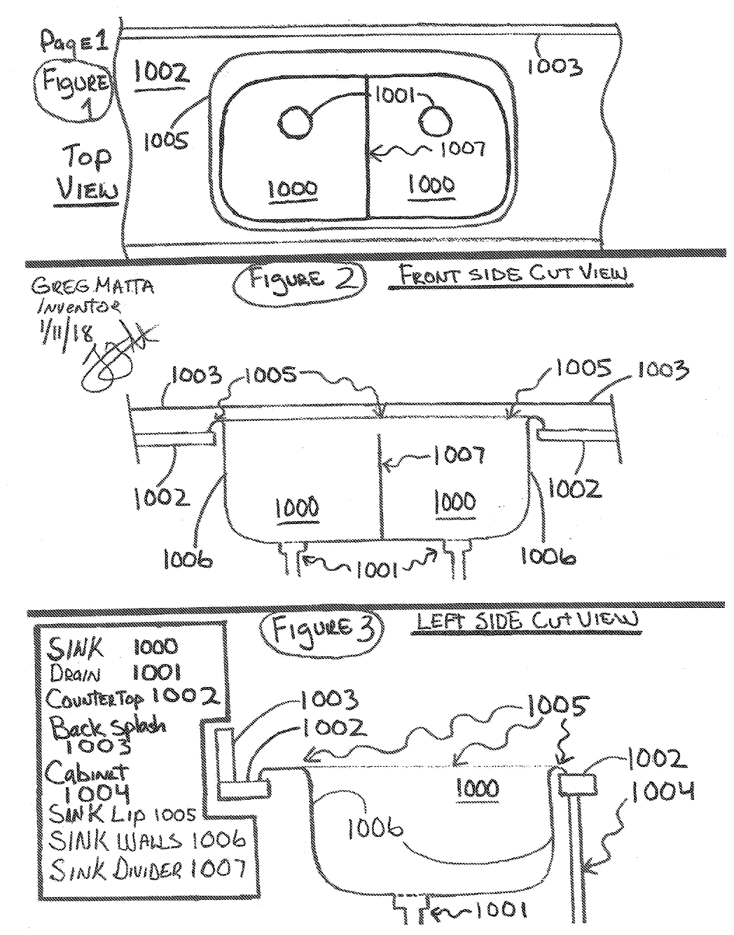

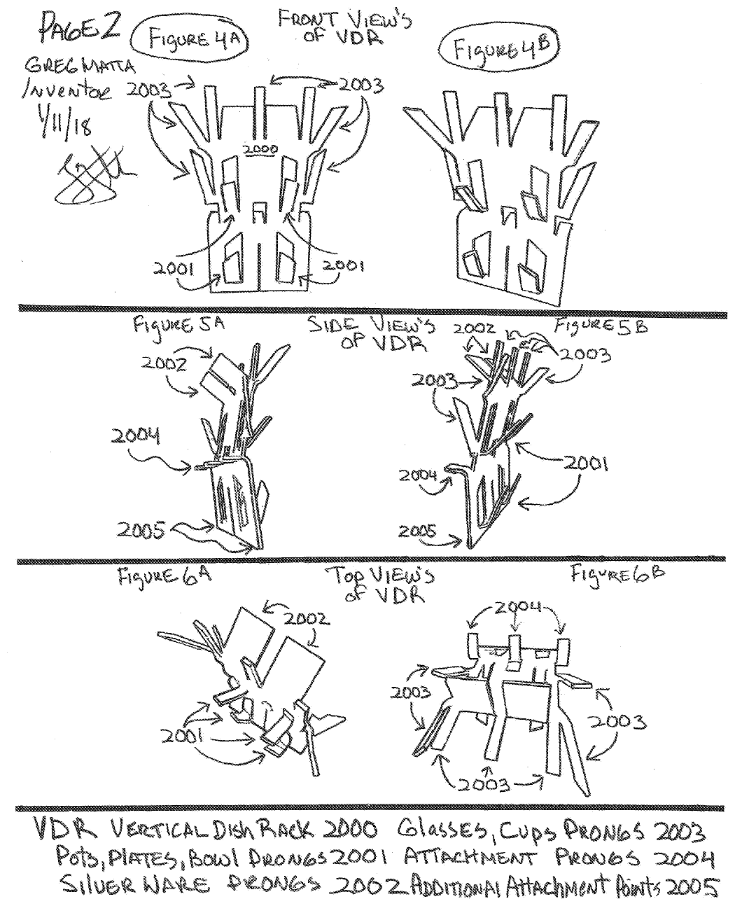

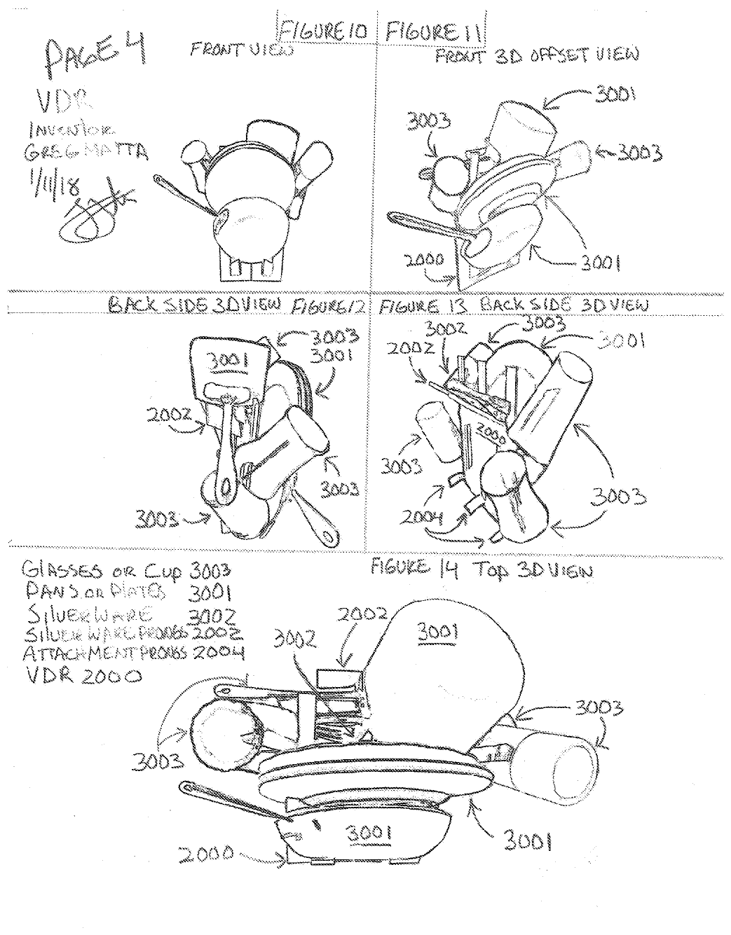

The vertical holding rack (VHR) 2000 works in most common sinks 1000 found in kitchens, bathrooms, RV'S, and sinks in work areas. This typical sink is found on page 1 in FIGS. 1, 2 and 3 showing different views of the top, front and side of a standard sink 1000 sitting on a countertop 1002. This bis an older way of a sink being installed and now they have sinks that go underneath the countertop. This product will work with that kind of sink all so. The present device, the VHR 2000 is shown on page 2 in FIGS. 4, 5 and 6 showing the front, side and top views. FIGS. 4A and 4B show the four prongs 2001 that protrude out in a hooking form that will hold plates, frying pans and bowls, etc., as shown on page 4 in FIGS. 10 through 14.

On page 2 FIGS. 4A and 4B show the seven prongs 2003 that holds cups, glasses, bowls, silverware, etc. In FIGS. 5A and 5B is a side view of the VHR 2000, it's also showing the prongs 2001 protruding out in a hooking form and showing three of the 2003 prongs standing up straight and the other 4 are slightly offset. FIGS. 5A, 5B and 6A are showing the silverware prongs 2002 showing the holding spot for the silverware 3002. FIGS. 6A and 6B show a top view of the VHR 2000 like in FIGS. 5A, 5B, 4A and 4B, showing all the prongs in front and back. Page 2, FIG. 6B shows the 3 attachment prongs 2004 and the additional attachment 2005 with locations shown on page 3, FIG. 9 if needed for additional weight loads.

### Vhr Simple Install

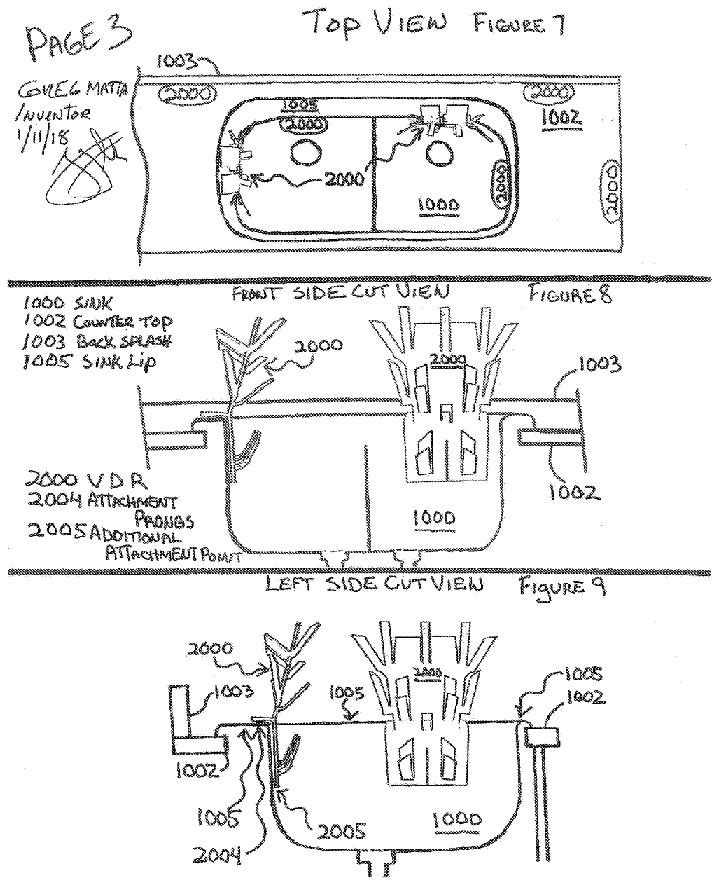

The present device, the VHR 2000 is easy to install, uninstall, and to use. On page 3, in FIGS. 7,8 and 9 all you do is place it you want to see if it works with the three attachment prongs 2004 to touch the sink lip 1005 in FIG. 9 or other creative mounting spots on FIG. 7, the circled 2000 spots. You have to make sure that the attachment spots are clean, using rubbing alcohol as needed. Then peel off the 3 protective tape off the recommended 3M plastic Velcro dual lock weather resistant 10 pound squares that are attached at the end of the 3 attachment prongs 2004 that are on the VHR 2000. Then push VHR 2000 up against the sink wall 1006 and then slide it down into the predetermined place, then push down the attachment prongs 2004 that are on the sink lip 1001 and hold for 30 seconds.

### VHR Simple Uninstall

The present device is the VHR 2000 when you have used it and you're done, remove it and put it under the kitchen sink if a permanent installation is not desired. To remove it, grab the leg anchor, which is the lower part of the VHR 2000 where the additional attachment points 2005 are and pull it out horizontally off the sink wall 1006 and it will release from the attachment points 2004. That is where the Velcro locks are at and will split the Velcro that holds it into place. So when you want to reuse it or if you permanently want it there you can just push back in place push down and it will lock into place. The standard installed VHR product without the additional attachment points has been tested and can hold up to 30 pounds of weight. This is due to the sink walls 1006 for the leg anchor to support to, so the VHR 2000 can cantilever up from the attachment prongs 2004 to balance the support weight and stabilize the load of dishes on the vertical dish rack. The Velcro plastic dual locks have a horizontal holding force of 10 pounds each totaling up to 30 pounds and the attachment prongs have 30 pounds of strength in the arm of the attachment prong. Depending on the thickness of the material that the VHR 2000 is made out of this product can hold up to 60 pounds of weight and up depending on the engineering of the VHR 2000 and its different types of applications.

### The Mechanics of VHR

The present device, the VHR 2000 is a device that cantilevers up the sink wall 1006 to the attachment prong 2004 point. Then continues to go up and above the sink, creating a stable vertical holding device that takes up no counterspace or sink space which is the present invention vertical dish rack. The present device the VHR 2000 has the additional attachment points 2005 at the end of the vertical dish racks leg anchor which supports the rack. This is why the top part of the rack stays in place and its kicked over 2 to 3 degrees into the sink and lets the water drip into the sink. So when loaded up to and tested to 30 pounds of dishes and this will create more stabilization of the top part of the rack. If your dishes or whatever have a lot of weight to it you can also add two more of the 3M squares to the additional attachment points 2005 shown in FIG. 5A to carry more weight load of the dishes 3001 and stabilize the VHR 2000 even more. The present invention of the VHR 2000 when installed properly is shown on page 3 in FIGS. 7, 8 and 9 showing the different views identical to page 1, but now there is a VHR 2000 installed. FIG. 7 is showing just the two actual top view drawings of VHR 2000 and showing five other possible different locations with the 2000 with a circle around them. In FIG. 8 shows the VHR 2000 installed looking at the front views install and in the side views of the VHR are the attachment prongs 2004. The attachment prongs 2004 are sitting on top of the sink lip 1005 attached with the recommended 3M plastic Velcro dual lock weather resistant 10 pounds or it can be attached in numerous other ways. These are not recommended by us after testing these many ways are with magnetics, glue, screws, two-way extreme weather tape, snaps, twist locks. The present invention the VHR 2000 has its standard recommended way of attaching and unattached from the sink without leaving any damage to the sink and working efficiently with taking up no room correctly in your standard kitchen sink improving the method and system of your standard drying systems.

### The VHR Working Efficiently

The present device is the VHR 2000 when loaded with dishes it is holding frying pans, pots, dishes 3001, glasses 3003, silverware 3002. This is shown on page 4 holding all of the dishes for a meal for 3 people shown in FIGS. 10, 11, 12, 13 and 14 showing all the different views. In FIGS. 10, 11, 12, and 14 are identical drawings in different views to show and demonstrate how it holds the exact same 3 dishes, one frying pan, one-pot with four glasses and a handful of silverware. This is done with a front view, a front 3D offset view A backside 3D view and a top view. In FIG. 13 it's the same view as FIG. 12 but the pot 3001 is missing so you can see where the silverware 3002 sets in the silverware prongs 2002 and this is also found in FIGS. 13 and 14 on page 4. The present device the VHR 2000 the top part of the rack can hold big pots and pans that won't fit in the dishwashing machine and they're in the way when drying and take up a lot of room. So this is a perfect solution for a big family or restaurant cooking efficiency and a place to have the big pot or big frying pan dry out of the way and not have to go into the dishwasher and take up a ton of room up in the dishwasher.

### Classifications

A47I19/02 Draining-boards
A47L 19/04 Crockery-baskets: Draining-racks.

Cited by

| Publication | Priority | Publication | | |
|---|---|---|---|---|
| number | date | date | Assignee | Title |
| US20080135505A1 | 2006 May 25 | 2008 Jun. 12 | Rubbermaid | Dish Drainer |
| | | | Incorporated | |
| US20080185352A1 | 2007 Feb. 2 | 2008 Aug. 7 | O'hara Morgan | Stemware |
| | | | Whitney | Drying rack |

What is claimed:

1. A vertical holding rack comprising:
a. A holding rack, wherein the rack is vertical, having a said front side, two edge sides and a top edge side with a half back side cantilever support leg, with holding prongs, and attachment prongs:
i. Wherein this attachment prongs go to a said predetermined mounting spot for the said attachment prongs to attached too, to secure the vertical rack for use;
1. Wherein as the front side, side edges and top have hold prongs for an object to be held on the said vertical holding rack.

2. The vertical holding rack of claim 1, wherein the vertical holding rack is very simple to install and remove and put back again, not damaging the surface area that its mounts to, reusable, portable, also a permanent device.

3. The vertical holding rack of claim 2, wherein the said vertical holding rack makes countertops more efficient with more working room because the device is a vertical rack and takes up no horizontal holding surface space.

4. The vertical holding rack of claim 1, wherein the said vertical holding rack, more particularly to one of the different possibilities of application of the device is holding dishes for the kitchen sink, wherein the device name for this application will be Vertical dish rack.

5. The vertical holding rack of claim 4, wherein the said vertical dish rack attaches to sink wall and leans over the sink for water to drip into the sink, therefore eliminating a need for water catching diverter device.
